(19) United States
(12) Patent Application Publication
(10) Pub. No.: US 2024/0063833 A1
(43) Pub. Date: Feb. 22, 2024

(54) BROADBAND HIGH POWER TRANSMIT/RECEIVE SWITCH SYSTEM

(71) Applicant: Infineon Technologies AG, Neubiberg (DE)

(72) Inventors: Ruediger Bauder, FeldkirchenWesterham (DE); Thomas Leitner, Pregarten (AT)

(21) Appl. No.: 18/450,139

(22) Filed: Aug. 15, 2023

Related U.S. Application Data
(60) Provisional application No. 63/371,574, filed on Aug. 16, 2022.

(51) Int. Cl. H04B 1/00; H04B 1/18

(52) U.S. Cl. CPC H04B 1/006; H04B 1/18

(57) ABSTRACT

A switch system includes a first hybrid coupler having a first node coupled to a termination terminal, a second node coupled to an antenna terminal, a third node coupled to a quadrature terminal, and a fourth node coupled to an in-phase terminal; and a radio frequency (RF) switch having a first switch coupled between the quadrature terminal and ground, and a second switch coupled between the in-phase terminal and ground, wherein the termination terminal is configured for coupling to a load, wherein the load and the RF switch dissipate RF power due to a transmit mode insertion loss, and wherein a majority of the RF power is reflected into the load by the first hybrid coupler.

### CROSS-REFERENCE TO RELATED APPLICATIONS

This application claims the benefit of U.S. Provisional Application No. 63/371,574, filed on Aug. 16, 2022, and to co-pending U.S. application Ser. No. ______ (not yet assigned) filed on the same day as this application, entitled “BROADBAND TRX HYBRID IMPLEMENTATION” and associated with Attorney Docket No. INF 2022 P 07356 US01, both of which applications are hereby incorporated herein by reference.

### TECHNICAL FIELD

The present invention relates generally to a broadband high power transmit/receive switch system, and a corresponding method.

### BACKGROUND

Time division duplexed (TDD) active antenna systems (AAS) are known in the art for use in, for example, 5G networks (5th generation mobile networks). Active antenna systems (AAS) are used to increase the capacity and coverage of radio streams. Active antenna systems feature a tighter integration of radio frequency (RF) electronics with a multiple-element antenna array to enable miniaturization and to boost efficiency. 5G base stations apply a high number of transmit and receive antenna elements for serving multiple users with parallel data streams. Some active antenna systems include a digital baseband transceiver, an RF frontend, and the multiple-element antenna array. The digital baseband transceiver can include a digital baseband and field-programmable gate array section, a mixed signal section including digital-to-analog converters (DACs) and analog-to-digital converters (ADCs), and a transceiver section for receiving and transmitting RF analog signals. The RF frontend can include driver amplifiers, power amplifiers, variable gain amplifiers, low noise amplifiers, and filters, as well as high voltage RF switching circuitry. In some applications, the RF switching circuitry can experience extremely high RF voltages. To handle these high RF voltages, the switching circuitry must be designed to include multiple stacked transistor stages increasing circuit area and costs. Furthermore, the extremely high RF voltages can lead to premature switching circuit failure.

### SUMMARY

According to an embodiment, a switch system comprising a first hybrid coupler having a first node coupled to a termination terminal, a second node coupled to an antenna terminal, a third node coupled to a quadrature terminal, and a fourth node coupled to an in-phase terminal; and a radio frequency (RF) switch having a first switch coupled between the quadrature terminal and ground, and a second switch coupled between the in-phase terminal and ground, wherein the termination terminal is configured for coupling to a load, wherein the load and the RF switch dissipate RF power due to a transmit mode insertion loss, and wherein a majority of the RF power is reflected into the load by the first hybrid coupler.

A method of operating a switch system, the switch system including a hybrid coupler having a first node configured for coupling to a load, a second node configured for coupling to an antenna, a third node, and a fourth node; and a radio frequency (RF) switch having a first switch coupled between the third node and ground, and a second switch coupled between the fourth node and ground, the method comprising turning off the first switch and the second switch such that RF power is dissipated in the load and the RF switch due to a transmit mode insertion loss, and such that a majority of the RF power is reflected into the load.

A receive path for a radio frequency (RF) frontend comprising a hybrid coupler having a first input configured for coupling to a load, a second input configured for coupling to an antenna, a first output, and a second output; an RF switch configured for selectively coupling the first output and the second output to ground; and a low noise amplifier circuit coupled to the RF switch, wherein the load and the RF switch dissipate RF power due to a transmit mode insertion loss, and wherein a majority of the RF power is dissipated by the hybrid coupler.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram of an exemplary time division duplexed (TDD) active antenna system (AAS);

FIG. 2 is a block diagram of an exemplary switch system for the AAS shown in FIG. 1;

FIG. 3A is a block diagram of a switch system for an AAS according to an embodiment;

FIG. 3B is a portion of the switch system of FIG. 3A, according to another embodiment;

FIG. 4 is an annotated equivalent circuit of the switch system of FIG. 3A during a transmit mode of operation;

FIG. 5 is a graph of the frequency characteristics of the switch system of FIG. 3A; and

FIG. 6 is an annotated equivalent circuit of the switch system of FIG. 3A during a receive mode of operation.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

In the following detailed description, reference is made to the accompanying drawings, which form a part hereof and in which are shown by way of illustrations specific embodiments in which the invention may be practiced. It is to be understood that other embodiments may be utilized and structural or logical changes may be made without departing from the scope of the present invention. For example, features illustrated or described for one embodiment can be used on or in conjunction with other embodiments to yield yet a further embodiment. It is intended that the present invention includes such modifications and variations. The examples are described using specific language, which should not be construed as limiting the scope of the appending claims. The drawings are not scaled and are for illustrative purposes only. For clarity, the same or similar elements have been designated by corresponding references in the different drawings if not stated otherwise.

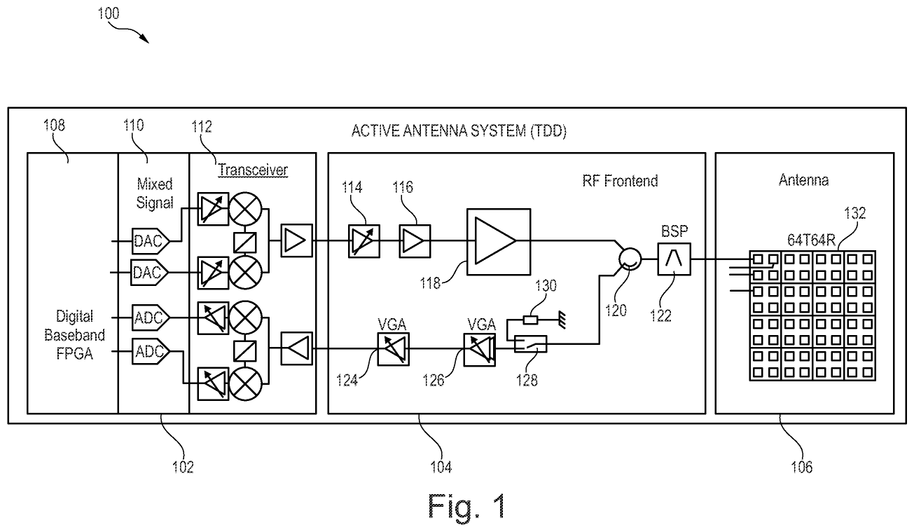

FIG. 1 is a block diagram of an exemplary time division duplexed (TDD) active antenna system (AAS) boo. AAS 100 includes a digital baseband transceiver 102, an RF frontend 104, and a multiple-element antenna array 106. The digital baseband transceiver 108 can include a digital baseband and field-programmable gate array section, a mixed signal section no including digital-to-analog converters (DACs) and analog-to-digital converters (ADCs), and a transceiver section 112 for receiving and transmitting RF analog signals, including amplifiers, a transmit (TX) modulator, and a receive (RX) demodulator. A transmit path of RF frontend 104 includes a variable pre-driver amplifier 114, a driver amplifier 116, and a power amplifier 118. A receive path of the RF frontend 104 includes a high voltage RF switching circuit 128 coupled to a load 130 and to a low noise amplifier (LNA) 126. The LNA 126 is coupled to a variable gain amplifier 124. The RF switching circuit 128 includes multiple stacked transistor stages to withstand the extremely high RF voltages that are present in some modes of operation. A stacked switch or stacked switching circuit is defined herein as a stack of “N” transistors or transistor stages, wherein “N” is an integer equal to or greater than one. The RF frontend 104 also includes a circulator 120 coupled to the receive and transmit paths, as well as a band pass filter 122. The multiple-element antenna array 106 can include a 64T64R massive multiple-input multiple-output (MIMO) antenna 132 including 64 transmit and 64 receive antenna elements.

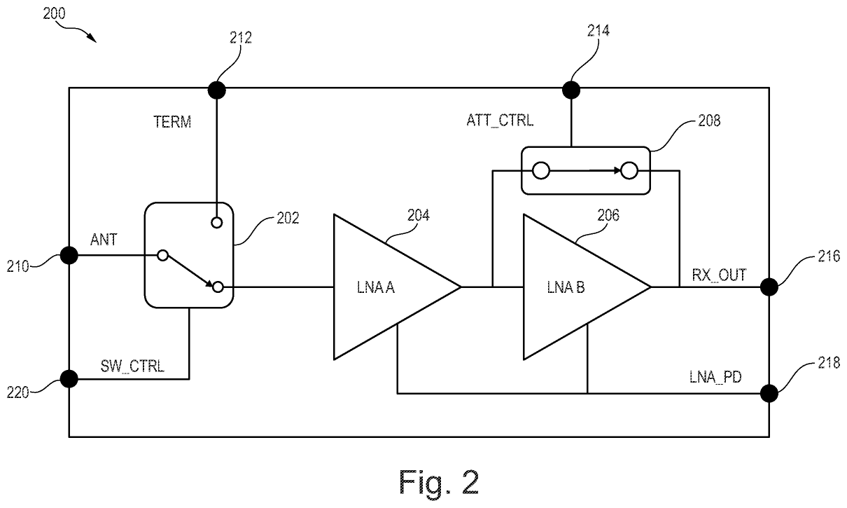

FIG. 2 is a block diagram of an exemplary switch system 200 for the AAS 100 shown in FIG. 1. Switch system 200 corresponds to the RF switching circuit 128 and LNA 126 shown in FIG. 1. Switch system 200 includes an RF switch 202 having an input coupled to the ANT antenna node 210, a first output coupled to the TERM termination node 212, and a second output coupled to an input of a first low noise amplifier LNA A 204. RF switch 202 is controlled by a SW CTRL switch control signal at node 220. An output of LNA A 204 is coupled to an input of a second low noise amplifier LNA B 206. An output of LNA B is coupled to the receive output RX OUT at node 216. LNA B 206 is selectively bypassed by RF switch 208 coupled between the input and the output of LNA B. RF switch 208 is controlled by an attenuation control signal ATT CTRL at node 214. The power or ground connection for low noise amplifiers LNA A and LNA B is designated LNA PD at node 218.

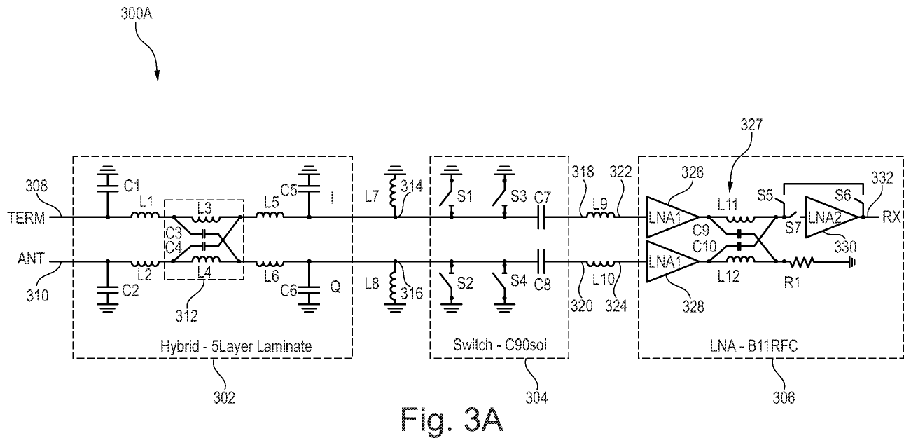

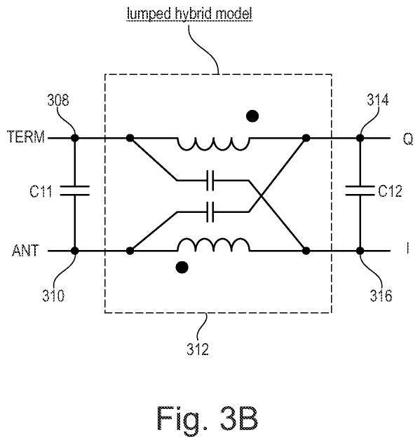

According to the embodiment of FIG. 3A, an RF switch system 300A includes a hybrid coupler 302 having inputs coupled to termination (TERM) and antenna (ANT) nodes; an RF switch 304 having inputs coupled to outputs of the hybrid coupler 302; and a low noise amplifier circuit 306 having inputs coupled to the RF switch 304 and an output coupled to a receive node (RX). In a transmit mode of operation, the hybrid coupler 302 allows the majority of the RF power at the termination to be reflected back into the termination and antenna nodes. The voltage across the RF switch is closed in the transmit mode of operation, which simplifies the switch design and reduces circuit area and manufacturing costs. In a receive mode of operation, due to a matching hybrid coupler in the low noise amplifier as well as other features described in further detail below, noise performance is improved. According to embodiments, the RF switch system provides additional performance improvements including compensation of RF switch parasitics and improved Electrostatic Discharge (ESD) performance. Embodiment RF switch systems, advantages, and features are described in further detail below with respect to FIGS. 3A-7. It is important to note that the hybrid 302, switch 304, and the low noise amplifier circuit 306 of FIG. 3A can be substituted into the high voltage RF switching circuit 128, low noise amplifier (LNA) 126, and variable gain amplifier 124 shown in FIG. 1, and into the switch system 200 shown in FIG. 2.

In an embodiment, the hybrid coupler is tuned to an operating RF frequency of interest. Hybrid couplers are the special case of a four-port directional coupler that is designed for a 3-dB (equal) power split. Hybrids couplers come in two types, 90 degree or quadrature hybrids, and 180 degree hybrids. In embodiments, the components of the hybrid couplers are designed to provide a quadrature hybrid coupler at the frequency of interest.

FIG. 3A is a block diagram of an RF switch system 300A for an AAS according to an embodiment. Switch system 300A comprises a first hybrid coupler 302 having a first node coupled to a TERM termination terminal 308, a second node coupled to an ANT antenna terminal, a third node coupled to a “Q” quadrature terminal 316, and a fourth node coupled to an “I” in-phase terminal 314. RF switch system 300A also comprises a radio frequency (RF) switch 304 having a first switch S1 coupled between the in-phase terminal 314 and ground, and a second switch S2 coupled between the quadrature terminal 316 and ground, wherein the termination terminal 308 is configured for coupling to the load 130 (shown in FIG. 1), wherein the load 130 and the RF switch 304 dissipate RF power due to a transmit mode insertion loss, and wherein a majority of the RF power is reflected into the load 130 by the first hybrid coupler 302. In an embodiment, during a transmit mode of operation, at least 90% of the RF power is reflected into the load 130 and less than 3% of the RF power is dissipated in the RF switch 304. RF switch system 300A also comprises a low noise amplifier circuit having inputs coupled to terminal 322 and terminal 324, and an output coupled to the RX receive output at terminal 332.

In an embodiment, the first hybrid coupler 302 comprises two coupled lines of a multi-layer laminated hybrid, the RF switch 304 comprises an integrated circuit affixed to the multi-layer laminated hybrid, and the low noise amplifier circuit 306 comprises one or more integrated circuits and optional external components.

A lumped-model equivalent circuit 312 of the two coupled lines of the first hybrid coupler 302 includes inductor L3 and inductor L4, capacitor C3 coupled between a first end of inductor L3 and a second end of inductor L4, and capacitor C4 coupled between a first end of inductor L4 and a second end of inductor L3. Further components of the first hybrid coupler 302 includes parasitic inductor L1 coupled to the first end of inductor L3, parasitic inductor L2 coupled to the first end of inductor L4, parasitic inductor L5 coupled to the second end of inductor L3, and parasitic inductor L6 coupled to the second end of inductor L4. The first hybrid coupler 302 further comprises capacitor C1 coupled between terminal 308 and ground, capacitor C2 coupled between terminal 310 and ground, capacitor C5 coupled between terminal 314 and ground, and capacitor C6 coupled between terminal 316 and ground. These parasitic components model the package parasitics of the hybrid, in an embodiment. Capacitors C1, C2, C5, and C6 are capacitances for tuning the RF characteristics of the first hybrid coupler 302.

Switch system 300A of FIG. 3 further comprises a first inductor L7 coupled between the in-phase terminal 314 and ground, and a second inductor L8 coupled between the quadrature terminal 316 and ground.

In some embodiments, the RF switch 304 comprises a third switch S3 also coupled between the in-phase terminal 314 and ground, and a fourth switch S4 also coupled between the quadrature terminal 316 and ground. The parallel configuration of switches S1 and S2, and S3 and S4 are used in some embodiments for greater reliability and high input power handling ability. Quality is improved by sharing the high input power handling between two switches. Switches S1 and S2 are switched together and switches S3 and S4 are also switched together. The operation and control of switches S1, S2, S3, and S4 is described in further detail below. RF switch also includes DC blocking capacitors C7 coupled between terminals 314 and 318 and C8 coupled between terminals 316 and 320. DC blocking capacitors C7 and C8 can be omitted in some embodiments depending on the design of the low noise amplifier circuit 306.

Switch system 300A of FIG. 3 further comprises a third inductor L9 coupled between terminal 318 and terminal 322, and a fourth inductor L10 coupled between terminal 320 and terminal 324.

In an embodiment, inductors L7, L8, L9, and L10 are non-parasitic inductors. Inductors L7 and L8 are used for parasitic capacitance compensation of the input capacitance of RF switch 304. In particular, inductors L7 and L8 are used to compensate the Coff capacitance of RF switch 304 and to provide improved ESD protection. In an embodiment, inductors L7 and L8, and the Coff capacitance of RF switch 304 creates a resonant tank circuit at the RF frequency of interest (high AC impedance). Inductors L9 and L10 are used to match the input capacitance of the low noise amplifier circuit 306. Adjusting component values using matching techniques are known in the art, for example using a Smith Chart or using RF matching software. In some embodiments, a noise match is made in order to decrease the noise figure of the system, even though the resulting match may result in some reflection.

In an embodiment, low noise amplifier circuit 306 comprises low noise amplifier 326 having an input coupled to terminal 322 and a low noise amplifier 328 coupled to terminal 324. The outputs of low noise amplifier 326 and low noise amplifier 328 are coupled to a second hybrid coupler 327 including inductor L11 and inductor L12, capacitor C9 coupled between a first end of inductor L11 and a second end of inductor L12, and capacitor C10 coupled between a first end of inductor L12 and a second end of inductor L11. Inductors L11 and L12, and capacitors C9 and C10 represent a lumped element model of the second hybrid coupler 327. Low noise amplifier circuit 306 further comprises low noise amplifier 330 selectively coupled between the second hybrid coupler 327 through switches S5, S6, and S7 and the RX output at terminal 332. When additional gain from low noise amplifier 330 is required switches S5 and S6 are open and switch S7 is closed. When additional gain is not required, switches S5 and S6 are closed and switch S7 is open to bypass low noise amplifier 330. The second hybrid coupler 327 can comprise an on-chip hybrid on the one or more low noise amplifier integrated circuits. In some embodiments the second hybrid coupler can comprise a discrete Surface Mount Device (SMD) implementation using separate inductors and capacitors, or an implementation similar to that used for the first hybrid coupler 302 (multi-layer laminate hybrid). The second hybrid coupler 327 is “matched” to the first hybrid coupler 302 as is explained in further detail below.

In the receive mode of operation, the ANT signal at terminal 308 is split into the I/Q signal at terminals 314 and 316. These signals pass through RF switch 304 (i.e., switches S1, S2, S3, and S4 are open) and be routed to the inputs of low noise amplifier 326 and low noise amplifier 328. Low noise amplifier 326 and low noise amplifier 328 amplify the I/Q signal. The second hybrid coupler 327 sums the amplified I/Q signal into a single-ended signal. This single-ended signal will be either amplified by low noise amplifier 330 or directly routed to the RX terminal 332 as explained above. The first hybrid coupler 302 (specifically the equivalent circuit 312) is “matched” with the second hybrid coupler 327. The term “matched” is defined herein as both hybrid couplers 302 and 327 having the same amplitude and phase characteristics. The matched hybrid couplers advantageously results in the noise at the TERM terminal 308 being cancelled.

FIG. 3B is a portion of the switch system of FIG. 3A, according to another embodiment including the first equivalent circuit 312 having inputs coupled to the TERM terminal 308 and the ANT terminal 310, and having outputs coupled to the Q terminal 316 and the I terminal 314. Not all of the inductors and capacitors from FIG. 3A are shown in FIG. 3B. In pertinent part, FIG. 3B shows a first capacitor C11 coupled between the TERM terminal 308 and the ANT terminal 310, and a second capacitor coupled between the quadrature terminal 316 and the in-phase terminal 314. Capacitor C11 and capacitor C12 can be used as additional tuning elements for the first hybrid coupler 302.

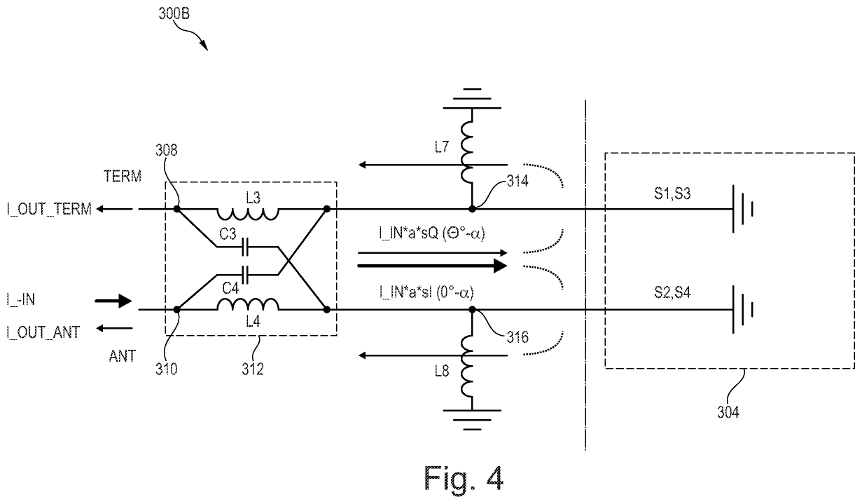

FIG. 4 is an annotated equivalent circuit 300B of the switch system 300A of FIG. 3A during a transmit mode of operation. During the transmit mode of operation switches S1, S2, S3, and S4 of RF switch 304 are closed and are simply represented by a short circuit to ground. The equivalent circuit 312 of the two coupled lines of the first hybrid coupler 302 remains in the circuit coupled to the termination terminal 308, the antenna terminal 310, terminal 314, and terminal 316. Equivalent circuit 300B also includes inductor L7 coupled to terminal 314 and inductor L8 coupled to terminal 316.

In operation, the input RF current into the antenna terminal is reflected back through the termination terminal 308 and the antenna terminal 310 with a split ratio of approximately 0.5. By placing the first hybrid coupler 302 in front of RF switch 304 at least 90% of the input RF power is dissipated in the first hybrid coupler 302 and less than 3% of the input RF power is dissipated in the RF switch 304.

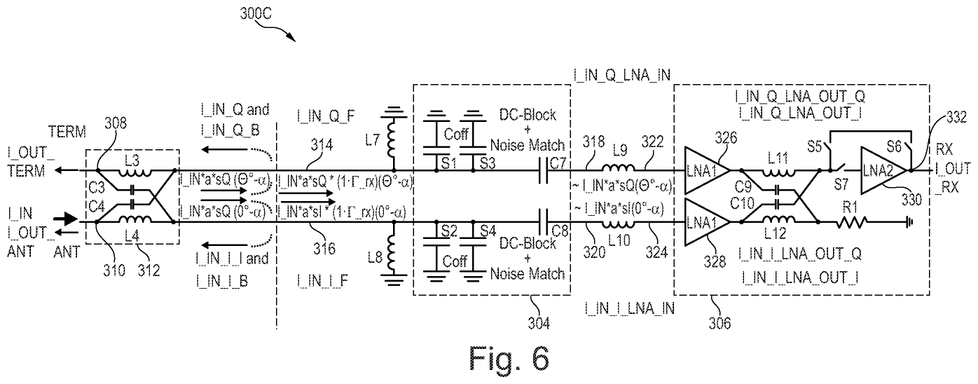

In FIG. 4, the input current at the antenna terminal 310 is designated “I_IN”, the reflected current at the antenna terminal 310 is designated “I_OUT_ANT” and the reflected current at the termination terminal 308 is designated “I_OUT_TERM”. Both of the reflected currents are equal to the sum of the following two currents, which are further described below with respect to the description of FIG. 6:

I_IN*a*sQ(Θ°−α); and [1]

I_IN*a*sI(0°−α), wherein [2]
“a” is hybrid loss,
“sQ” and “sI” are the split ratios from the ANT to the I/Q port=−3 dB=0.5,
“α” is the phase shift due to signal propagation from the ANT port to I/Q or I/Q to the termination port of the input hybrid coupler 312,
“0°” is a zero degree phase shift, and
“Θ°” is a phase difference between the I/Q channel for the hybrid=90°.

It is important to note that switches S1, S2, S3, and S4 of the RF switch 304 are shown as short circuits in the transmit mode equivalent circuit of FIG. 4. The design of RF switch 304 can thus be significantly simplified (for example, fewer stacked transistors are needed when compared to prior art solutions exposed to high voltages across the switch). In the transmit mode, the switches of RF switch 304 are closed and, despite the high voltages at the termination and antenna terminals, the voltage across each of the switches is substantially equal to zero volts. In the receive mode, high voltage signals are generally not present, and thus the switches in RF switch need only be designed to accommodate these low voltage signals.

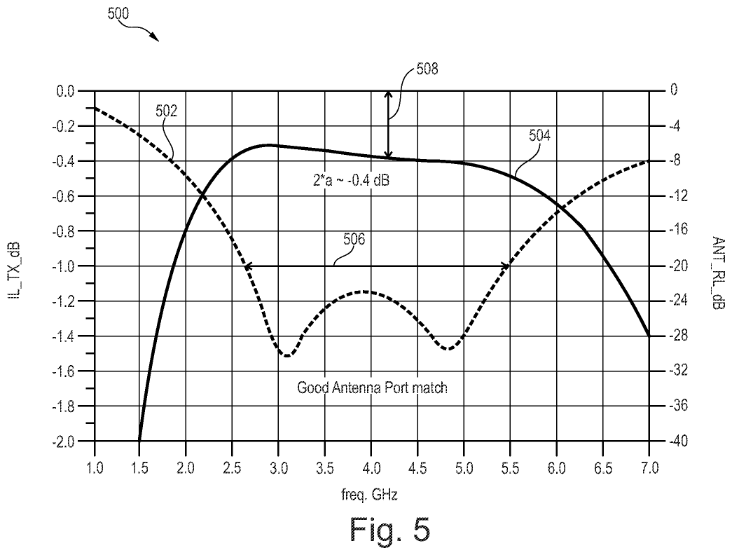

FIG. 5 is a graph 500 of the frequency characteristics of the switch system 300A of FIG. 3A during the transmit mode of operation. Embodiments described herein advantageously provide a high return loss and a low insertion loss. For example, graph 400 shows an antenna port match within a frequency range 506 between the frequencies of about 2.5 GHz to about 5.5 GHz. Frequency curve 502 is the return loss at the antenna terminal 310 (ANT_RL_dB) having a return loss between about −20 dB and −28 dB within frequency range 506. Frequency curve 504 is the insertion loss in the transmit mode of operation between the antenna terminal 310 and the termination terminal 308 (IL TX dB) having a hybrid loss 508 of about −0.4 dB within frequency range 506.

FIG. 6 is an annotated circuit of the switch system of FIG. 3A during a receive mode of operation. The RF switch system 300C in FIG. 6 includes a lumped-model equivalent circuit 312 of the two coupled lines of the first hybrid coupler 302, an RF switch 304, a low noise amplifier circuit 306, as well as additional components all previously shown and described. A terminal load is coupled to the TERM terminal 308 but is not explicitly shown in FIG. 6 for convenience. The load 130 is best seen in FIG. 1.

The input current at the ANT terminal 310 is I_IN, the reflected current at the ANT terminal 310 is I_OUT_ANT, and the reflect current at the TERM terminal 308 is I_OUT_TERM. The current components at the output of first hybrid coupler 302 include I_IN_I, which is the in-phase signal from the first hybrid coupler 302 and is described by equation [2] set forth above, I_IN_I_B, which is the back-scattered in=phase signal from the first hybrid coupler 302, I_IN_Q, which is the quadrature phase signal from the first hybrid coupler 302 and is described by [1] set forth above, and I_IN_Q_B, which is the back scattered quadrature phase signal from the first hybrid coupler 302.

The input current components to the RF switch 304 include I_IN_Q_F, which is the forward-scattered quadrature phase signal from the first hybrid coupler 302, and I_IN_I_F, which is the forward scattered in-phase signal from the first hybrid coupler 302. Current components I_IN_Q_F and I_IN_I_F are respectively described by the following:

I_IN*a*sQ*(1−Γ_rx)(Θ°−α); and [3]

I_IN*a*sI*(1−Γ_rx)(0°−α). [4]

The output current components from the RF switch 304, which are also current components to the inputs of the low noise amplifier circuit 306, are labeled I_IN_I_LNA_IN and I_IN_Q_LNA_IN. I_IN_I_LNA_IN is the forward-scattered in-phase signal from the first hybrid coupler 302 into LNA circuit 306 in the in-phase path and is approximately equal to I_IN_I, previously defined. I_IN_Q_LNA_IN is the forward-scattered quadrature phase signal from the first hybrid coupler 302 into LNA circuit 306 in the quadrate path and is approximately equal to I_IN_Q, previously defined.

The output current components from the LNA circuit 306 are labeled, from the top of FIG. 6, I_IN_Q_LNA_OUT_Q, I_IN_Q_LNA_OUT_I, I_IN_I_LNA_OUT_Q, and I_IN_I_LNA_OUT_I, and are defined by the following equations:

I_IN_Q_LNA_OUT_Q˜I_IN*a*b*sQ*sI2((Θ+0)°−α−β); [5]

I_IN_Q_LNA_OUT_I˜I_IN*a*b*sI*sQ2((0+ϕ)°−α−β); [6]

I_IN_I_LNA_OUT_Q˜I_IN*a*b*sQ*sQ2((Θ+ϕ)°−α−β); and [7]

I_IN_I_LNA_OUT_I˜I_IN*a*b*sI*sI2((0)*−α−β), [8]

wherein, with respect to [3], [4], [5], [6], [7], and [8]:
“a” is the input hybrid loss;
“b” is the output hybrid loss;
“sI” is the power split ratio I_IN to I path of input hybrid;
“sI2” is power split ratio LNA 326 to switch S7 through inductor L11 and the power split ratio LNA 328 to resistor R1 through inductor L12;
“sQ” is the power split ratio I_IN to Q path of the input hybrid;
“sQ2” is the power split ratio LNA 326 to resistor R1 through C9 and the power split ratio LNA 328 to switch S7 through capacitor Cm;
α is the I, Q output common mode phase of input hybrid;
β is the I, Q output common mode phase of output hybrid;
Θ is the quadrature offset phase of the Q path of the input hybrid;
Φ is the quadrature offset phase of the Q path of the output hybrid; and
Γ_rx is the reflection coefficient in the receive mode at a plane parallel to inductor L7 and the reflection coefficient in the receive mode at a plane parallel to inductor L8.

Finally, the output currents of the RF switch system 300C in FIG. 6 are given by the following equations:

I_OUT_TERM=I_IN*a*sQ*Γ_rx*(2*Θ°−2*α)+I_IN*a*sI*Γ_rx*(2*Θ°−2*α) [9]

I_OUT_ANT=I_IN*a*sQ*Γ_rx*(0°−2*α)+I_IN*a*sI*Γ_rx*(2*Θ°−2*α) [10]

I_OUT_RX˜I_IN*a*b*sQ*sI2*((Θ+0)°−α−β)+I_IN*a*b*sI*sQ2*((0+Φ)°−α−β) [11]

for sI=sQ and Θ=90° with respect to equations [9] and [10], and for sQ=sI=sQ2=sI2=0.5, a=b=1, and Θ=Φ with respect to equation [11].

The following description is related to noise cancellation in the RF switch system of the present invention, according to embodiments.

From an outside observer at the ANT port 310, any reflections at the noise matched LNA lineup reference plane at Γ_rx will be scattered back to the first hybrid coupler 302 and will be terminated at the load resistor in the TERM port 308. As such, the observer at the ANT port 310 will not detect a back-scattered wave at the ANT port 310. This is by definition a perfect noise match at the ANT port 310.

Inside the hybrid island of hybrid coupler 302, the LNA will be optimized for the best noise figure (NF), which is not a perfect match, but best for NF. Since reflections will propagate to the TERM port 308 and not the ANT port 310, the match seen from the ANT port 310 is still perfect. Just the Γ_rx based gain drop at each chain (I and Q path) will be slightly lower than the available power gain of the LNA lineup.

At the TERM port 308, there is a termination resistor R TERM 130 with the value of Zo (e.g. a 50 Ohm characteristic Impedance). Such a resistive device typically has a thermal noise voltage which can be converted to a thermal noise current. This noise current will propagate from TERM port 308 of the first hybrid 302 to the TERM port (input of LNA2) of the second hybrid 327 with the same equation as the input signal current I_IN at the ANT port 310 of the first hybrid to the input of LNA2 330.

Example embodiments of the present invention are summarized here. Other embodiments can also be understood from the entirety of the specification and the claims filed herein.
Example 1. According to an embodiment, a switch system comprises a first hybrid coupler having a first node coupled to a termination terminal, a second node coupled to an antenna terminal, a third node coupled to a quadrature terminal, and a fourth node coupled to an in-phase terminal; and a radio frequency (RF) switch having a first switch coupled between the quadrature terminal and ground, and a second switch coupled between the in-phase terminal and ground, wherein the termination terminal is configured for coupling to a load, wherein the load and the RF switch dissipate RF power due to a transmit mode insertion loss, and wherein a majority of the RF power is reflected into the load by the first hybrid coupler.
Example 2. The switch system of Example 1, wherein at least 90% of the RF power is reflected into the load and less than 3% of the RF power is dissipated in the RF switch.
Example 3. The switch system of any of the above examples, wherein the first switch and the second switch are closed in a transmit mode of operation.
Example 4. The switch system of any of the above examples, further comprising a first inductor coupled between the quadrature terminal and ground, and a second inductor coupled between the in-phase terminal and ground.
Example 5. The switch system of any of the above examples, wherein the first inductor and the second inductor are configured to shunt an ESD current input at the antenna terminal to ground.
Example 6. The switch system of any of the above examples, wherein the first inductor and the second inductor, and an input capacitance of the RF switch comprises a resonant tank circuit at an RF frequency of interest.
Example 7. The switch system of any of the above examples, wherein the first hybrid coupler comprises two coupled lines of a multi-layer laminated hybrid coupler.
Example 8. The switch system of any of the above examples, wherein the RF switch comprises an integrated circuit affixed to the multi-layer laminated hybrid coupler.
Example 9. The switch system of any of the above examples, wherein the RF switch comprises a third switch coupled between the quadrature terminal and ground, and a fourth switch coupled between the in-phase terminal and ground.
Example 10. The switch system of any of the above examples, wherein the RF switch further comprises a first capacitor interposed between the quadrature terminal and a first internal node, and a second capacitor interposed between the in-phase terminal and a second internal node.
Example 11. The switch system of any of the above examples, further comprising a third inductor coupled between the first internal node and a third internal node, and a fourth inductor coupled between the second internal node and a fourth internal node.
Example 12. The switch system of any of the above examples, further comprising a low noise amplifier circuit coupled to the third internal node, a fourth internal node, and a receive terminal.
Example 13. The switch system of any of the above examples, wherein the low noise amplifier circuit comprises a first low noise amplifier and a second low noise amplifier.
Example 14. The switch system of any of the above examples, further comprising a second hybrid coupler coupled to the first low noise amplifier, and second low noise amplifier, and a receive terminal, wherein the second hybrid coupler is matched to the first hybrid coupler.
Example 15. The switch system of any of the above examples, wherein an antenna match is determined by the first hybrid coupler, and wherein a noise match is determined between the RF switch and inputs of the low noise amplifier circuit.
Example 16. According to an embodiment, a method of operating a switch system, the switch system including a hybrid coupler having a first node configured for coupling to a load, a second node configured for coupling to an antenna, a third node, and a fourth node; and a radio frequency (RF) switch having a first switch coupled between the third node and ground, and a second switch coupled between the fourth node and ground, comprises turning off the first switch and the second switch such that RF power is dissipated in the load and the RF switch due to a transmit mode insertion loss, and such that a majority of the RF power is reflected into the load.
Example 17. The method of Example 16, wherein at least 90% of the RF power is reflected into the load and less than 3% of the RF power is dissipated in the RF switch.
Example 18. The method of any of the above examples, wherein the hybrid coupler comprises two coupled lines of a multi-layer laminated hybrid coupler.
Example 19. The method of any of the above examples, wherein the RF switch comprises an integrated circuit affixed to the multi-layer laminated hybrid coupler.
Example 20. According to an embodiment, a receive path for a radio frequency (RF) frontend comprises a hybrid coupler having a first input configured for coupling to a load, a second input configured for coupling to an antenna, a first output, and a second output; an RF switch configured for selectively coupling the first output and the second output to ground; and a low noise amplifier circuit coupled to the RF switch, wherein the load and the RF switch dissipate RF power due to a transmit mode insertion loss, and wherein a majority of the RF power is dissipated by the hybrid coupler.
Example 21. The receive path of Example 20, further comprising a first inductor coupled between the first output and ground, and a second inductor coupled between the second output and ground.
Example 22. The receive path of any of the above examples, wherein the hybrid coupler comprises two coupled lines of a multi-layer laminated hybrid coupler.
Example 23. The receive path of any of the above examples, wherein the RF switch comprises a first integrated circuit, and wherein the low noise amplifier circuit comprises a second integrated circuit.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A switch system comprising:
a first hybrid coupler having a first node coupled to a termination terminal, a second node coupled to an antenna terminal, a third node coupled to a quadrature terminal, and a fourth node coupled to an in-phase terminal; and
a radio frequency (RF) switch having a first switch coupled between the quadrature terminal and ground, and a second switch coupled between the in-phase terminal and ground,
wherein the termination terminal is configured for coupling to a load, wherein the load and the RF switch dissipate RF power due to a transmit mode insertion loss, and wherein a majority of the RF power is reflected into the load by the first hybrid coupler.

2. The switch system of claim 1, wherein at least 90% of the RF power is reflected into the load and less than 3% of the RF power is dissipated in the RF switch.

3. The switch system of claim 1, wherein the first switch and the second switch are closed in a transmit mode of operation.

4. The switch system of claim 1, further comprising a first inductor coupled between the quadrature terminal and ground, and a second inductor coupled between the in-phase terminal and ground.

5. The switch system of claim 4, wherein the first inductor and the second inductor are configured to shunt an ESD current input at the antenna terminal to ground.

6. The switch system of claim 4, wherein the first inductor and the second inductor, and an input capacitance of the RF switch comprises a resonant tank circuit at an RF frequency of interest.

7. The switch system of claim 1, wherein the first hybrid coupler comprises two coupled lines of a multi-layer laminated hybrid coupler.

8. The switch system of claim 7, wherein the RF switch comprises an integrated circuit affixed to the multi-layer laminated hybrid coupler.

9. The switch system of claim 1, wherein the RF switch comprises a third switch coupled between the quadrature terminal and ground, and a fourth switch coupled between the in-phase terminal and ground.

10. The switch system of claim 1, wherein the RF switch further comprises a first capacitor interposed between the quadrature terminal and a first internal node, and a second capacitor interposed between the in-phase terminal and a second internal node.

11. The switch system of claim 10, further comprising a third inductor coupled between the first internal node and a third internal node, and a fourth inductor coupled between the second internal node and a fourth internal node.

12. The switch system of claim 11, further comprising a low noise amplifier circuit coupled to the third internal node, a fourth internal node, and a receive terminal.

13. The switch system of claim 12, wherein the low noise amplifier circuit comprises a first low noise amplifier and a second low noise amplifier.

14. The switch system of claim 13, further comprising a second hybrid coupler coupled to the first low noise amplifier, and second low noise amplifier, and a receive terminal, wherein the second hybrid coupler is matched to the first hybrid coupler.

15. The switch system of claim 12, wherein an antenna match is determined by the first hybrid coupler, and wherein a noise match is determined between the RF switch and inputs of the low noise amplifier circuit.

16. A method of operating a switch system, the switch system including a hybrid coupler having a first node configured for coupling to a load, a second node configured for coupling to an antenna, a third node, and a fourth node; and a radio frequency (RF) switch having a first switch coupled between the third node and ground, and a second switch coupled between the fourth node and ground, the method comprising:
turning off the first switch and the second switch such that RF power is dissipated in the load and the RF switch due to a transmit mode insertion loss, and such that a majority of the RF power is reflected into the load.

17. The method of claim 16, wherein at least 90% of the RF power is reflected into the load and less than 3% of the RF power is dissipated in the RF switch.

18. The method of claim 16, wherein the hybrid coupler comprises two coupled lines of a multi-layer laminated hybrid coupler.

19. The method of claim 18, wherein the RF switch comprises an integrated circuit affixed to the multi-layer laminated hybrid coupler.

20. A receive path for a radio frequency (RF) frontend comprising:
a hybrid coupler having a first input configured for coupling to a load, a second input configured for coupling to an antenna, a first output, and a second output;
an RF switch configured for selectively coupling the first output and the second output to ground; and
a low noise amplifier circuit coupled to the RF switch,
wherein the load and the RF switch dissipate RF power due to a transmit mode insertion loss, and wherein a majority of the RF power is dissipated by the hybrid coupler.

21. The receive path of claim 20, further comprising a first inductor coupled between the first output and ground, and a second inductor coupled between the second output and ground.

22. The receive path of claim 20, wherein the hybrid coupler comprises two coupled lines of a multi-layer laminated hybrid coupler.

23. The receive path of claim 20, wherein the RF switch comprises a first integrated circuit, and wherein the low noise amplifier circuit comprises a second integrated circuit.
